(19) United States
(12) Patent Application Publication
(10) Pub. No.: US 2006/0063495 A1
(43) Pub. Date: Mar. 23, 2006

(54) Mitigation of electromagnetic interference

(75) Inventor: Tony Hamilton, Durham, NC (US)

Correspondence Address: Venable LLP, P.O. Box 34385, Washington, DC, 20043-9998, US

(73) Assignee: Intel Corporation, Santa Clara, CA (US)

(21) Appl. No.: 10/944,715

(22) Filed: Sep. 21, 2004

(51) Int. Cl. H04B 1/38

(52) U.S. Cl. 455/90.3

(57) ABSTRACT

A system design may include electromagnetic sensors and/or placement of components to address problems of near-field electromagnetic interference caused by a processor within the system, and may further include measures to mitigate interference when detected.

### BACKGROUND OF THE INVENTION

Electromagnetic interference (EMI) is a problem faced in many communication systems. EMI may be generated by many sources, and its effects may, in part, depend upon the proximity of the source to the communication system; this may be of particular concern, for example, in wireless transmit and receive devices. More and more, communicating devices, such as computers, personal digital assistants (PDAs), mobile telephones, etc., may contain processors or other components that operate at high frequencies, and which may thus generate EMI in a frequency range in which the device communicates. Consequently, such EMI may interfere with communications to and/or from the device.

### BRIEF DESCRIPTION OF THE DRAWINGS

Various embodiments of the invention will now be described in connection with associated drawings, in which:

FIG. 1 depicts a block diagram of a system according to an exemplary embodiment of the invention;

FIG. 2 depicts a block diagram of a specific exemplary embodiment of the invention;

FIG. 3 depicts a flowchart according to a further embodiment of the invention; and

FIG. 4 depicts a flowchart according to a variation on the embodiment of the invention shown in FIG. 3.

### DETAILED DESCRIPTION OF EMBODIMENTS OF THE INVENTION

In the following description, numerous specific details are set forth. However, it is understood that embodiments of the invention may be practiced without these specific details. In other instances, well-known circuits, structures, and/or techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

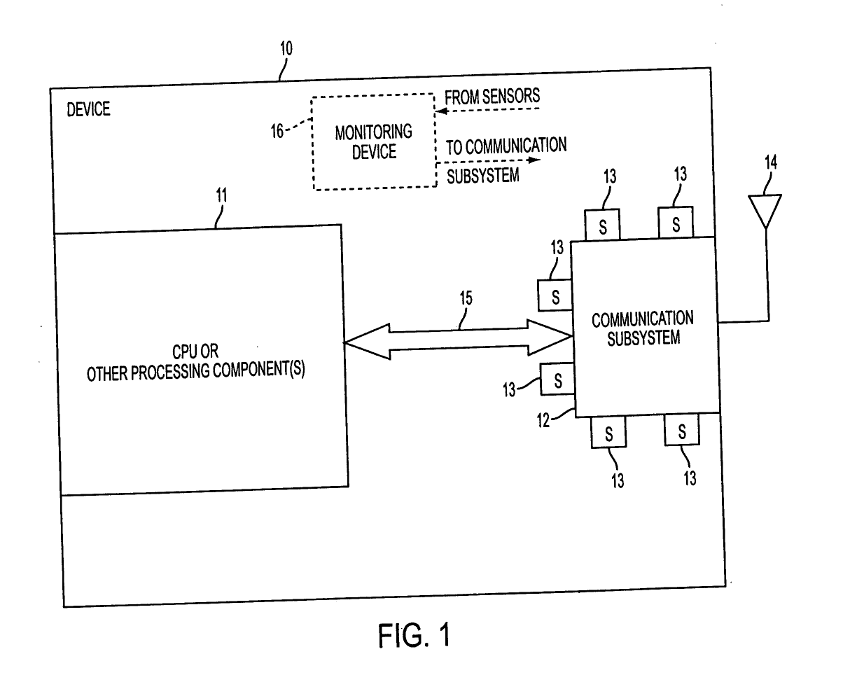

FIG. 1 depicts a block diagram showing an exemplary embodiment of a system according to the invention. A device 10 that is capable of communication may contain a CPU and/or other processing components 11. It may further include a communication subsystem 12. Communication subsystems, such as communication subsystem 12, may include various components, including, but not limited to, transmitters, receivers, processors, and logic. Communication subsystem 12 may be connected to an antenna 14, which may comprise, but is not limited to, an unipole, a dipole, an array, a conformal antenna, or a dish antenna.

In a system like device 10, processing components 11, or even processing components within communication subsystem 12, may be operated at relatively high frequencies and may generate energy at one or more fundamental and/or harmonic frequencies that may coincide with frequencies used for wireless communication by communication subsystem 12. Furthermore, this may occur when processing components 11 run some applications but not others. Such energy may then interfere with communication by the communication subsystem 12.

As an illustrative example, to which the invention is not limited, a CPU 12 may be operating at some clock frequency, say 2.4 GHz. Key business applications running on such a CPU 12 may lead to the generation of fundamental and harmonic energy in the Industrial, Scientific and Medical (ISM) frequency band. Communications subsystem 12 may be, for example, a wireless local area network (WLAN) interface transmitting and receiving on various frequencies within the ISM band. The near-field EMI resulting from the fundamental and harmonic energy may lead to significant interference with communications to and from communications subsystem 12. As a result, quality of service (QoS) issues may arise (e.g., with respect to error rates, throughput, etc.).

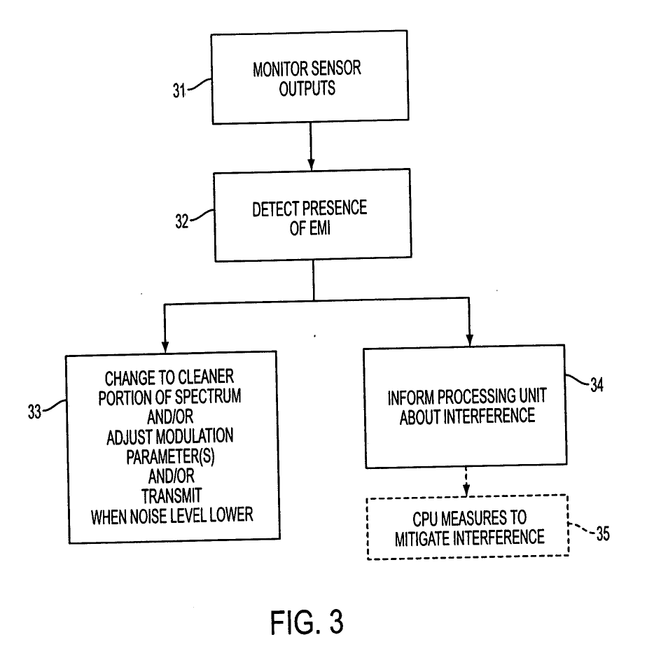

In the embodiment of the invention shown in FIG. 1, this problem may be addressed by providing one or more sensors (S) 13 in proximity to communication subsystem 12. Sensors 13 may be used to detect the presence of EMI at communication subsystem 12 in frequency bands used for communication. Sensors 13 may be monitored by communication subsystem 12 in some embodiments of the invention. Alternatively, they may be monitored by another component 16 of device 10, which may communicate with communication subsystem 12 to report monitoring results. Communication subsystem 12 may further communicate with CPU or other processing component(s) 11 to convey information regarding EMI, as indicated by the arrow 15. Arrow 15 may, for example, represent a bus or other communication structure within device 10, and a handshaking or some other known or as yet to be discovered protocol may be used in such communication. The sensors 13 and associated monitoring and/or communications may be used in mitigating the effects of EMI, as will be further described below in conjunction with FIG. 3.

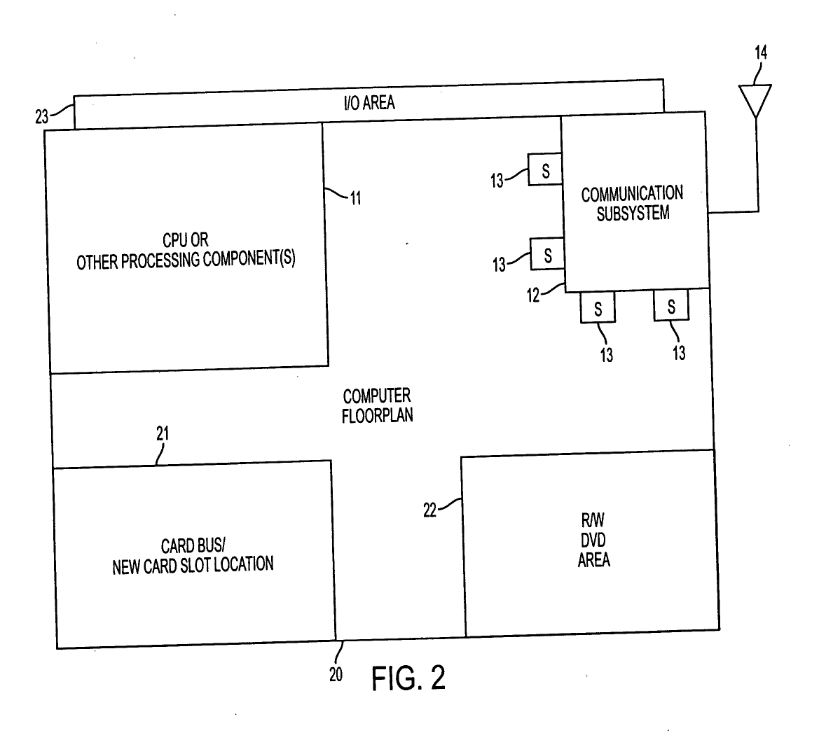

The above sensors may be used in conjunction with other techniques for minimizing EMI. For example, FIG. 2 shows a “floorplan” 20 of a computer, which may be, but is not limited to, a notebook computer. Floorplan 20 includes placement of a CPU 11 at the top left-hand side (LHS) of the floorplan 20; this may be done in notebook computer design in order, for example, to address thermal considerations. One may then place the communication subsystem 12 (and, if present, sensors 13 and antenna 14) at the upper right-hand side (RHS) of the floorplan 20, to ensure that it is physically separated from CPU 12. As shown in FIG. 2, other components, such as a card bus and/or card slot(s) 21 and a read/write/DVD area 22 may be placed as shown, relative to CPU 11 and communication subsystem 12. Furthermore, an input/output (I/O) area 23 may be provided, as shown, at the top of floorplan 20. Note that the entire floorplan 20 may be located within a housing, for example.

FIG. 3 shows a flowchart of a method according to an embodiment of the invention. In general the communication subsystem 12 (or alternative monitoring device, as discussed above) may monitor levels of energy detected by electromagnetic sensors 13, as shown in Block 31. Upon detection of the presence of EMI, Block 32, measures may be taken by one or both of the communication subsystem 12 and the CPU or other processing component(s) 11 to mitigate the effects of the EMI. In Block 33, the communication subsystem 12 may take measures, which may include, but are not limited to, changing to a “cleaner” (i.e., less noisy) portion of the spectrum and/or adjusting one or more modulation parameters of a transmitted signal (e.g., if orthogonal frequency division multiplexing (OFDM) is used, one may adjust a phase component of the OFDM signal). A further measure that may be taken by communication subsystem 12, in conjunction with other measures or by itself, is to delay transmission until a lower noise level is detected (Block 33); an acceptable lower noise level may be determined by a system designer. The communication subsystem 12, or alternative monitoring device, may inform the CPU or other processing component(s) 11 of the presence of the EMI, Block 34. Then, the CPU or other processing component(s) 11 may take further measures, Block 35, to mitigate the interference. Such further measures may include, but are not limited to, adjusting clock speed and/or scheduling of tasks, which may be done in conjunction with communication processing by communication subsystem 12 (that is, to avoid executing tasks causing interference during periods of communication, and vice versa).

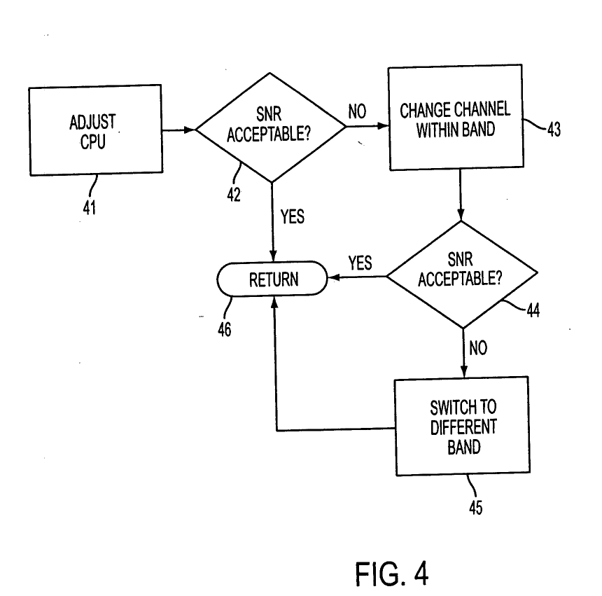

FIG. 4 depicts a flowchart describing a procedure that may be used to implement the interference mitigation portion of FIG. 3 (i.e., Blocks 33-35), according to a variation on the embodiment of the invention as shown in FIG. 3. When electromagnetic interference is detected, which may be, but is not limited to being, by means of comparing a signal-to-noise ratio (SNR) to predetermined threshold value that may represent a minimum acceptable SNR, the system may first respond by adjusting a clock rate of the CPU or other processing component(s) 11, as shown in Block 41. Following this, a test may be performed to determine if the SNR is at an acceptable level (Block 42). Should the SNR be acceptable, the procedure may end (Block 46). Should the SNR not be acceptable, the procedure may continue with Block 43. In Block 43, the communication subsystem 12 may attempt to change to a different channel (if any) within a communication band in which it is currently communicating. This may further involve the use of further SNR or other noise measurements to determine if there is a channel in the band with lower noise/higher SNR. Following this, the procedure may continue with Block 44 and may determine if the SNR is now acceptable. If so, then the procedure may end (Block 46). Otherwise, the procedure may continue with Block 45. In Block 45, the communication subsystem 12 may switch to a different band for communicating. This may be possible only if the communication subsystem 12 is capable of supporting communication in other bands. Additionally, Block 45 may involve testing other bands, prior to switching, to determine if another band would provide an improvement in SNR over the present communication band. This may involve further SNR and/or other noise measurements in the alternative bands.

The invention has been described in detail with respect to various embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

What is claimed is:

1. An apparatus, comprising:
a processor;
a communication subsystem; and
one or more electromagnetic energy sensors to detect electromagnetic energy emitted by said processor, said electromagnetic energy sensors coupled to said communication subsystem to provide information about detected electromagnetic energy levels to said communication subsystem.

2. The apparatus according to claim 1, wherein said processor and said communication subsystem are communicatively coupled.

3. The apparatus according to claim 2, further comprising:
a bus coupled between said processor and said communication subsystem.

4. The apparatus according to claim 2, wherein information communicated between said communication subsystem and said processor includes at least one of the group consisting of information about electromagnetic interference and instructions to mitigate electromagnetic interference.

5. The apparatus according to claim 2, wherein a handshaking protocol is employed between said processor and said communication subsystem.

6. The apparatus according to claim 1, further comprising:
a monitoring device coupled to said one or more sensors and to said communication subsystem.

7. A system, comprising:
a processor;
a communication subsystem;
an antenna coupled to said communication subsystem; and
one or more electromagnetic energy sensors to detect electromagnetic energy emitted by said processor, said electromagnetic energy sensors coupled to said communication subsystem to provide information about detected electromagnetic energy levels to said communication subsystem.

8. The system according to claim 7, further comprising:
a bus to communicatively couple said processor and said communication subsystem.

9. The system according to claim 7, further comprising:
an input/output interface.

10. A computer system comprising:
a housing;
a processor located within a first portion of said housing;
a communication subsystem located within a second portion of said housing, said second portion being adjacent to said first portion; and
one or more electromagnetic energy sensors to detect electromagnetic energy emitted by said processor, said electromagnetic energy sensors coupled to said communication subsystem to provide information about detected electromagnetic energy levels to said communication subsystem.

11. The computer system according to claim 10, further comprising at least one of the group consisting of a card bus and a card interface.

12. The computer system according to claim 10, further comprising:
at least one bus to communicatively couple said processor and said communication subsystem.

13. A method comprising:
monitoring output of one or more sensors;
detecting, based on said output, the presence of electromagnetic interference in at least one communication frequency band used by said communication subsystem and caused by a processor; and
taking one or more measures designed to mitigate the electromagnetic interference in said at least one communication frequency band.

14. The method according to claim 13, wherein said taking one or more measures comprises at least one of the group consisting of:
causing said communication subsystem to communicate using a different frequency band from said at least one communication frequency band;
causing said communication subsystem to communicate during a period when said electromagnetic interference is at an acceptable level; and
adjusting one or more parameters of a signal generated by said communication subsystem.

15. The method according to claim 13, wherein said taking one or more measures comprises:
communicating information regarding said electromagnetic interference to said processor.

16. The method according to claim 15, wherein said taking one or more measures further comprises at least one of the group consisting of:
adjusting a clock rate of said processor;
scheduling execution of tasks on said processor to reduce interference; and
scheduling communication by said communication subsystem to reduce interference.

17. The method according to claim 13, wherein said taking one or more measures comprises:
adjusting a clock rate of said processor;
determining if the electromagnetic interference is at an acceptable level; and
if the electromagnetic interference is not at an acceptable level, switching to a different channel within said at least one communication frequency band.

18. The method according to claim 13, wherein said taking one or more measures comprises:
adjusting a clock rate of said processor;
determining if the electromagnetic interference is at an acceptable level; and
if the electromagnetic interference is not at an acceptable level, switching said communication subsystem to use a different communication frequency band.

19. A machine-readable medium containing instructions that, when executed by a processor, cause said processor to execute a method comprising:
monitoring output of one or more sensors located in proximity to a communication subsystem;
detecting, based on said output, the presence of electromagnetic interference in at least one communication frequency band used by said communication subsystem and caused by a processor; and
taking one or more measures designed to mitigate the electromagnetic interference in said at least one communication frequency band.

20. The machine-readable medium according to claim 19, wherein said taking one or more measures comprises:
causing said communication subsystem to communicate using a different frequency band from said at least one communication frequency band.

21. The machine-readable medium according to claim 19, wherein said taking one or more measures comprises:
causing said communication subsystem to communicate during a period when said electromagnetic interference is at an acceptable level.

22. The machine-readable medium according to claim 19, wherein said taking one or more measures comprises:
adjusting one or more parameters of a signal generated by said communication subsystem.

23. The machine-readable medium according to claim 19, wherein said taking one or more measures comprises:
adjusting a clock rate of said processor causing said electromagnetic interference.

24. The machine-readable medium according to claim 19, wherein said taking one or more measures comprises at least one of the group consisting of:
scheduling execution of tasks on said processor causing said electromagnetic interference to reduce interference; and
scheduling communication by said communication subsystem to avoid interference.

25. The machine-readable medium according to claim 19, wherein said taking one or more measures comprises:
adjusting a clock rate of said processor;
determining if the electromagnetic interference is at an acceptable level;
if the electromagnetic interference is not at an acceptable level, switching to a different channel within said at least one communication frequency band.

26. The machine-readable medium according to claim 19, wherein said taking one or more measures comprises:
adjusting a clock rate of said processor;
determining if the electromagnetic interference is at an acceptable level; and
if the electromagnetic interference is not at an acceptable level, switching said communication subsystem to use a different communication frequency band.
